(19) United States
(12) Patent Application Publication
(10) Pub. No.: US 2013/0042112 A1
(43) Pub. Date: Feb. 14, 2013

(54) USE OF NON-INTERACTIVE IDENTITY BASED KEY AGREEMENT DERIVED SECRET KEYS WITH AUTHENTICATED ENCRYPTION

(71) Applicant: Brian P. Spector, Seattle, WA (US)

(72) Inventor: Brian P. Spector, Seattle, WA (US)

(73) Assignee: CertiVox Ltd., London (GB)

(21) Appl. No.: 13/368,726

(22) Filed: Feb. 8, 2012

Related U.S. Application Data
(60) Provisional application No. 61/442,235, filed on Feb. 12, 2011.

(51) Int. Cl. H04L 9/00

(52) U.S. Cl. 713/171

(57) ABSTRACT

A sender private key is created from a master key. The sender private key and public information about a recipient is used to produce a secret key. Data is encrypted with the secret key. The encryption uses authentication data. The encrypted data is sent to the recipient. A recipient private key is created from the master key. The recipient private key is different from the sender private key. The recipient private key and public information about the sender is used to recreate the secret key. At the recipient, the secret key is used to decrypt the encrypted data and the authentication data is used to authenticate the data.

### CLAIM OF PRIORITY

This application claims priority to U.S. Provisional Application No. 61/442,235 entitled “USE OF NON-INTERACTIVE IDENTITY BASED KEY AGREEMENT DERIVED SECRET KEYS WITH AUTHENTICATED ENCRYPTION”, by Brian P. Spector, filed Feb. 12, 2011, which is incorporated herein by reference.

### BACKGROUND

Encryption is used to protect and to keep secret messages and other data. Typically, the data is encrypted by a first user and then transferred to a second user who then can decrypt the data.

Symmetric key cryptography uses the same key at the sender and at the recipient. This requires a secure initial transfer of the keys. To avoid this problem, public key cryptography systems have been developed.

Public key cryptography uses mathematically related key pairs. One key of the key pair is a public key that is published and thus is not kept secret. The other key of the key pair is a secret private key. Data can be encrypted using the public key such that the encrypted data can only be decrypted using the private key. Typically, a Public Key Infrastructure (PKI) is used to distribute the public keys. Public key cryptography is more computationally intensive than symmetric key cryptography so often public key cryptography is used to encrypt a symmetric key for symmetric key cryptography of a larger message in what is called a hybrid system.

ID-based key agreement is a type of encryption key agreement protocol in which identification information is used in which two parties agree on an encryption key to secure their information exchange. One example of ID based key agreement uses pairings over elliptic curves and finite fields. The pairings allows a common key to be derived in two different ways at the sender and receiver. The use of ID-based key agreement can, in some cases, avoid the need for a PKI.

### SUMMARY

Embodiments of the present invention use non-interactive identity based authenticated key agreement protocol, such as by using bilinear pair derived secret keys and symmetric key authenticated encryption modes so that the entire encrypted file becomes a unique fingerprint.

The initialization vector in an authenticated encryption mode can be used as a data tracking mechanism, a globally unique identifier, an authentication mechanism and as a general catalyst for a business process. In particular, an embodiment of the invention can use the initialization vector to transport a specific digital rights expression. As an example, the digital rights expression may limit the number of times a document can be printed or a digitized song can be played. In another embodiment, the initialization vector includes a key escrow beneficiary identifier and a unique/random identification parameter used to obtain key escrow beneficiary private key, and create the decryption key programmatically using the beneficiary private key and unique/random identification parameter.

At the sender, a first private key is combined with ID information of a receiver as a programmatic input in an identity-based non-interactive key agreement protocol to produce a secret key. This secret key is used to encrypt data such as a message. The encryption is performed using an authenticated encryption mode that uses an initialization vector that is not required to be secret, only unique for each application of the encryption key. For example, in one embodiment, a unique initialization vector is used (along with the secret key) to encrypt the data and then the initialization vector is sent along with the encrypted data. At the receiver, a second private key is used along with ID information of the sender as a programmatic input in an identity-based non-interactive key agreement protocol to reproduce the secret key. The secret key along with the initialization vector, which can include authentication information and tracking data, is used to decrypt the encrypted data. The use of commonly known data fingerprinting techniques and the resulting data fingerprint hashes utilized as initialization vectors in the encrypted data can track data leaks by using the initialization vector to set the origin of the encrypted content, it can thus serve as a tracking mechanism for the encrypted content. The initialization vector can also include parameters such as date and time, location of creation, expiration time or other parameters.

The use of private keys to generate the secret key means that the key that decrypts the encrypted message need not be distributed. Instead, private keys that by themselves cannot decrypt the message are distributed along with the initialization vector information used in secret key cryptography. Initialization vectors used in authenticated encryption modes do not have to be secret, but they must have a unique value when the encryption key is used more than one time. The initialization vector information along with the use of the secret key allows for an encryption, fingerprint and signature method with built-in accountability without requiring public/private key computation and management overhead at the recipient's side.

In one embodiment, data is encrypted using compound parameters in the initialization vector. The initialization vector includes a key escrow beneficiary identifier and a unique/random identification parameter. The initialization vector is sent as part of the encrypted data to a decrypting entity that uses the key escrow beneficiary identifier portion of the initialization vector to obtain a key escrow beneficiary private key. The decrypting entity also uses the unique/random identification parameter portion of the initialization vector and the key escrow beneficiary private key to recreate the secret key which is the encryption key.

In one embodiment, the encrypted data is credit card and transaction data. The key escrow beneficiary need not store the encryption key so any intruders to the key escrow beneficiary system would not be able to decrypt the encrypted credit card and transaction data stored at the key escrow beneficiary. Further, the key escrow beneficiary benefits with increased security as each credit card and transaction stored is encrypted with a different key.

### BRIEF DESCRIPTION OF DRAWINGS

FIGS. 1A and 1B are diagrams that illustrate the use of secret keys along with an initialization vector.

FIG. 2 is a diagram that illustrates a key escrow system that uses an initialization vector which includes a key escrow beneficiary identifier and a unique/random identification parameter.

FIG. 3A is a diagram that illustrates the use of compound parameters within the initialization vector itself.

FIG. 3B is a diagram that illustrates the creation and/or recreation of the encryption key from the private key and the unique/random identification parameter.

### DETAILED DESCRIPTION OF THE PREFERRED EMBODIMENT

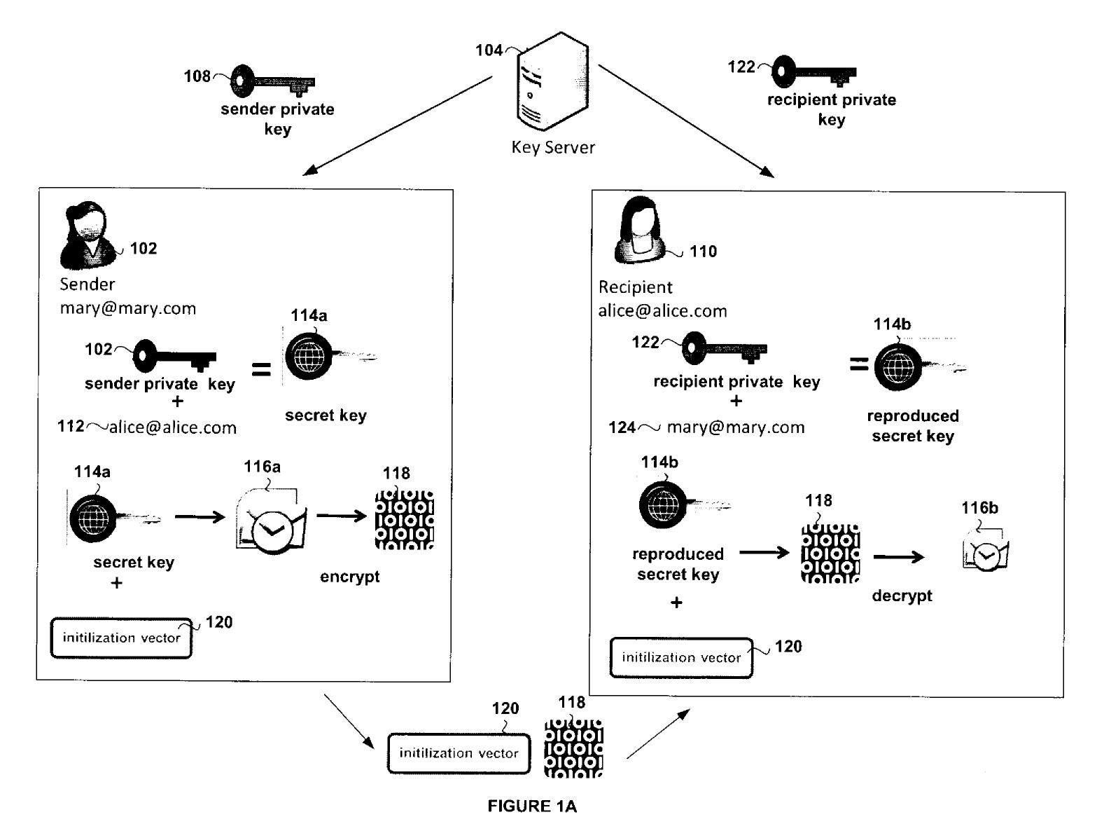

FIG. 1A shows the exemplary use of secret keys. In this example, the sender 102, Mary, enrolls with the key server 104 to get a sender private key 108. The sender private key 108 is programmatically utilized with identification information 112 of the recipient 110, Alice, to produce the secret key 114.

In this case, the recipient identification information 112 is the email address, “alice@alice.com”. The sender encrypts data 116a with the secret key 114a to produce the encrypted data 118.

In one embodiment, initialization vector 120 is used in the encryption so that encrypted data 118 is fingerprinted with the initialization vector 120. The initialization vector 120 can be used in the Authenticated Encryption modes such as AES-GCM. The initialization vector 120 is then sent along with the encrypted data 118 to the Recipient 110, Mary.

In one embodiment, an authentication tag is sent along with the initialization vector. The authentication tag can be used to authenticate the message along with the initialization vector. The initialization vector 120 can include a digital rights management expression, a timestamp, location of creation, information source or origin information, or data expiry information. The time stamp can indicate the time of creation of the encrypted data or the time of the creation of the source file. Because the initialization vector must remain static in order to decrypt the cipher text in an encrypted datum, the initialization vector helps to create a non-repudiated datum relative to digital rights expression, timestamp, location of creation, information source or origin information, or data expiry information

In one embodiment, the initialization vector is used to seed the encryption such that the encrypted data 118 will be different for different initialization vectors. In this way, the encrypted data 118 is thus fingerprinted by the initialization vector. The initialization vector can thus be used to track any “data leaks”.

The recipient 110 gets a recipient private key 122 from key server 104. The recipient private key 122 is used along with sender identification information 124 to reproduce the secret key 114. In this case, the sender identification information 124 is the email address, “mary@mary.com”.

The reproduced secret key 114b at the recipient 110 is the same as the secret key 114a at the sender 102. The key server creates the sender private key 108 and recipient private key 122 from a master key, such that when these keys are combined with the identification of the other party, each of the parties can create a secret key. For example, bilinear pairings can be used. The secret key is not transmitted in any form or via any communication protocol between the parties.

The reproduced secret key 114b is then used along with the initialization vector 120 to decrypt the encryption data 118 so as to reproduce the decrypted data 116b.

The key server 104 is adapted to create a sender private key 108 for a sender and a recipient private key 122 for a recipient. The sender private key 108 being different from the recipient private key 122. The sender private key 108 along with recipient ID information 112 is sufficient to produce a secret key 114a. The recipient private key 122 along with sender ID information 124 is sufficient to reproduce the secret key 114b.

When the secret key 114a is used to encrypt data along with the initialization vector 120 encrypted data 118 is produced. The encrypted data 118 can be fingerprinted and the fingerprint can be carried within the initialization vector 120. When the encrypted data 118 is decrypted using the reproduced secret key 114b at the recipient, the data can be authenticated using the initialization vector 120. The key server 104 can use code stored on a machine readable medium.

A machine readable storage medium at the sender 102 and recipient 110 can contain code to cause a machine at the sender 102 and recipient 104 to implement the encryption and decryption. At the sender 102, the code can cause a machine to obtain a sender private key 108; combine the sender private key 108 with recipient identification (ID) information 112 to produce a secret key 114a; encrypt data with the secret key 114a using the initialization vector 120 which carries a control parameter of the encrypted data 118; and send the encrypted data 118 and the initialization vector 120 to a recipient 110. In this way, the recipient 104 is able to reproduce the secret key 114b using sender control parameter information 124 and a recipient private key 122, and is able to decrypt the encrypted data 118 using the initialization vector to verify the fingerprint data 118 carried within the initialization vector 120.

FIG. 1B shows an alternate view of the method using secret keys and an initialization vector.

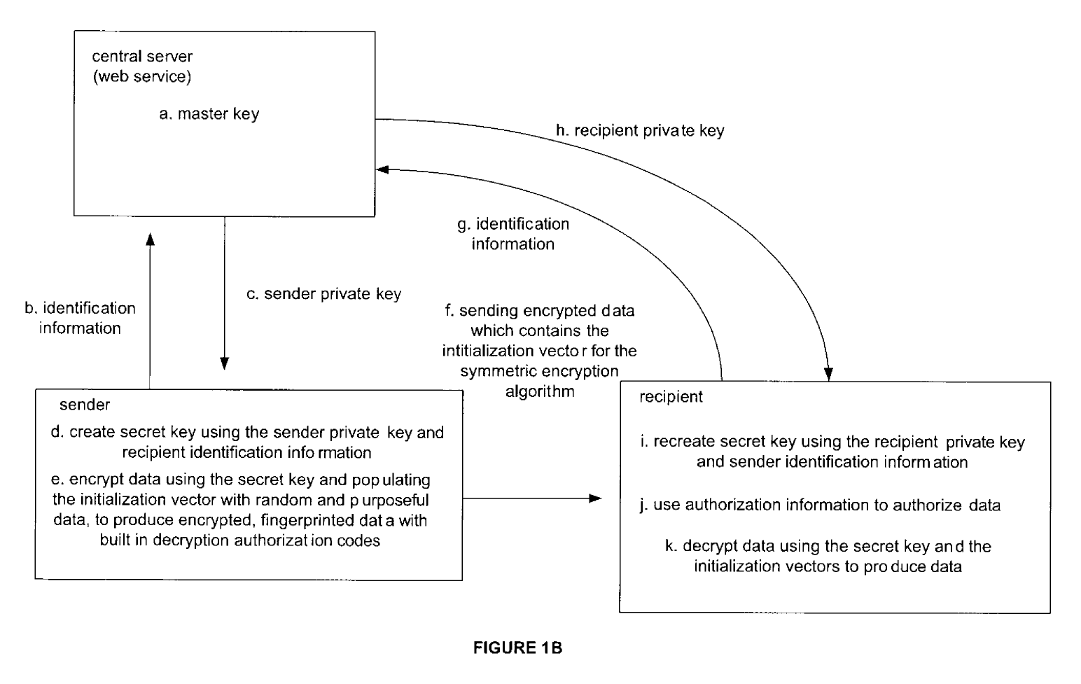

FIG. 2 is a diagram that illustrates a key escrow system that uses an initialization vector which includes a key escrow beneficiary identifier and a unique/random identification parameter.

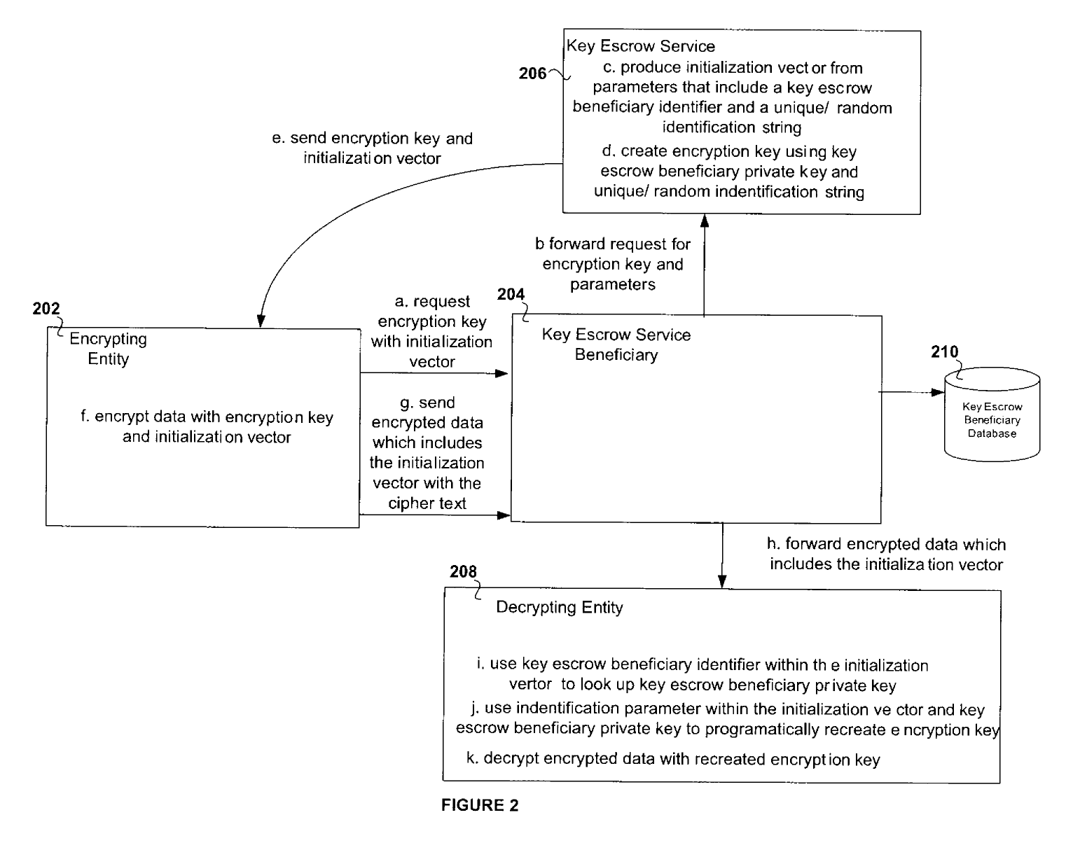

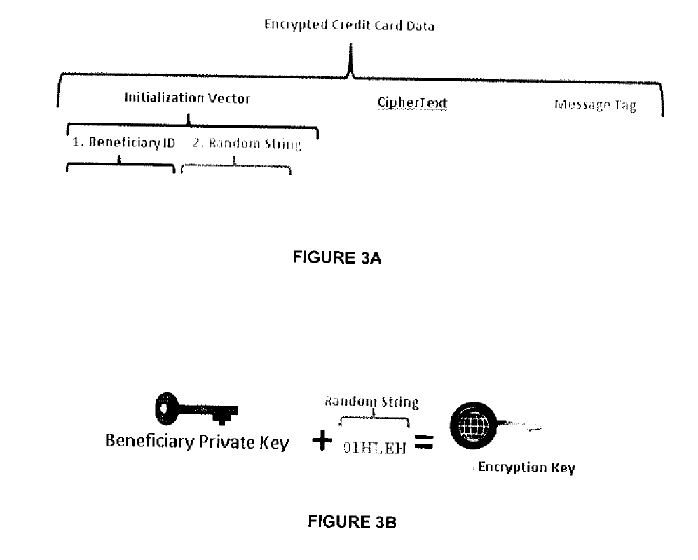

FIG. 3A is a diagram that illustrates the use of compound parameters within the initialization vector itself, as described above. FIG. 3B is a diagram that illustrates the creation and/or recreation of the encryption key from the private key and the unique/random identification parameter.

The following section describes details of one non-limiting example of the use of secret keys and an initialization vector. Although the method described below is an internet retailer and e-commerce transaction scenario, the scope of the field of use is also applicable for standalone credit card machines.

What is described is a data protection solution that uses non-interactive identity based key agreement, such as the uses non-interactive identity based key agreement system described by Sakai, Ohgishi and Kasahara, in combination with authenticated encryption, such as the authenticated encryption system described by the research papers of David McGrew and John Viega and their AES-GCM algorithm.

The data protection solution provides the benefits normally associated with the PAIN acronyms used to describe efficient and robust cryptographic systems; Privacy, Authentication, Non-repudiation and Integrity. This is accomplished without the complexities normally associated with public/private key cryptosystems, with the ease of secret key cryptography, and only by distributing a single private key on behalf of the beneficiary of the data protection solution.

There are four entities within the system; 1) a Private Key Escrow Service (the Service) 206, 2) an Encrypting Entity 202, 3) a Decrypting Entity 208 and 4) the beneficiary of the system, the Key Escrow Beneficiary 204. Note that the encrypting and decrypting entity may be the same entity, and may also be the beneficiary of the service as well.

In the instance where this system is applied for the benefit of protecting credit card data when a credit card is used in a purchasing transaction workflow using the internet, the scenario could be described thusly:

As shown in FIG. 2, the Encrypting Entity 202 which could be a machine with a browser capable of performing modes of authenticated encryption programmatically via scripting or native language capabilities visits the Key Escrow Beneficiary 204 such as the merchant website of a retailer in the system. The retailer has a secured connection to the Private Key Escrow Service 206 which performs the following functions when the user visits the checkout page on the retailer's website.

The Private Key Escrow Service 206 will receive an encrypted request from the Key Escrow Beneficiary 204 on behalf of the Encrypting Entity 202 to supply the Encrypting Entity 202 with a symmetric encryption key, which can be used in an authenticated encryption mode of the AES encryption algorithm, such as AES-GCM.

Additionally, the Private Key Escrow Service 206 will supply the identification parameters that are used in an authenticated key agreement scheme such as that as described by Sakai, Ohgishi and Kasahara. The identification parameters are used to create the symmetric key programmatically with beneficiary's private key as another parameter. The Private Key Escrow Service 206 operates an encryption key management service which uses a master key, from which all beneficiaries on the system have private keys which are derivatives of the master key.

In this method, the identification parameter itself serves two purposes; 1) to be used as the initialization vector in a mode of authenticated encryption such as AES-GCM, but also as the 2) non-secret parameters that enables the holder of the beneficiary's private key, in this method, the Decrypting Entity 208, to re-create, on-demand, the secret key used by the Encrypting Entity 202 on the data that was encrypted.

This secret key is used by the Decrypting Entity 208 at a later date or time and in a non-interactive manner, separate from the action of the Encrypting Entity 202.

Once a request is received by the Private Key Escrow Service 206, the Private Key Escrow Service 206 notes the source of the request, and uses the source as one half of the parameters which makes up the non-secret initialization vector. This serves to identify the actual beneficiary (Key Escrow Service Beneficiary 204) of the service.

It is worth noting that this example of the method takes particular advantage of the mechanics of authenticated encryption modes, in that these modes require an initialization vector, along with a key, and an authentication tag. The initialization vector has a requirement that it must be unique for every application of the key or else the key itself could be re-created by a malicious entity eavesdropping on the transmission. However, the initialization vector does not need to be secret, and in fact can be non-secret. This enables it to serve this dual purpose. The other beneficial element is that the mode of authenticated encryption removes the need for a separate hashing algorithm, as the hashing capability is built in with the use of the authentication tag.

The other half of the initialization vector is a randomly generated string, which used by the non-interactive authenticated key agreement protocol, such as that described by Sakai, Ohgishi and Kasahara, to generate the secret key when used in conjunction with the Key Escrow Beneficiary's 204 private key. In the classic application of a non-interactive authenticated identity based key agreement protocol, this would serve as the identity parameter.

The encrypting entity will receive these two parameters that make up the whole of the initialization vector, along with the unique AES encryption key that is created when the random string is programmatically used as an input in the non-interactive authenticated key agreement protocol, such as that described by Sakai, Ohgishi and Kasahara.

The main function of the Private Key Escrow Service 206 is to generate issue, hold, safeguard, and distribute securely the private key of the Private Key Service Beneficiary 204 and generate and securely distribute the encryption keys used by the Encrypting Entity 202.

Once the Encrypting Entity 202, is this case, the browser that visits the internet retailer's website receives the initialization vector and encryption key, the browser can programmatically encrypt data going into the retailer's system before being transmitted to the merchant, using a mode of authenticated encryption such as AES-GCM. Once this is completed the AES encryption key and any transaction information is destroyed. What is transmitted is only the encrypted credit card and transaction information.

The benefit of this is that the Decrypting Entity 208 can be a distinct system, separate from the internet retailer. In this case, the Decrypting Entity 208 will be the credit card payment processing system. By having the decryption processes occur at the payment processor, the scope of the merchant's card holder data responsibilities are significantly reduced, or disappear entirely. This improves the security of the buyer's (Encrypting Entity 202) credit card details and transaction details over systems and methods in use today. Additionally, the security of the merchant's database (the Key Escrow Beneficiary Database 210) which stores the credit card and transaction details by individual transaction is improved over systems and methods in use today, in that every individual transaction is uniquely encrypted using a different encryption key.

When the payment processing service (Decrypting Entity 208) receives a transaction from the retailer (Key Escrow Service Beneficiary 204) over the internet, the payment processing service (Decrypting Entity 208) uses the identification parameters stored in the initialization vectors carried within to overall body of the encrypted credit card and transaction information (known as cipher text) as the identification parameters necessary to 1) look up, locate and use the correct private key of the Key Escrow Beneficiary 204, itself in use at both the Private Key Escrow Service 206 and in use at the Decrypting Entity 208 and 2) the programmatic identity parameter used in an identity based, non-interactive authenticated key agreement scheme such as Sakai, Ohgishi and Kasahara.

Example workflow:

1. Utilize the key escrow beneficiary identifier inside of the initialization vector to source the correct private key.

2. Utilize the random string inside of the initialization vector as the identity parameters to be used programmatically in a non-interactive authenticated key agreement protocol.

3. Generate the secret key, in this method the AES decryption key. As outlined in step 2 and consistent with the methods express in identity based non-interactive authenticated key agreement protocols such as Sakai, Ohgishi and Kasahara.

4. Use the authenticated mode of AES, such as AES-GCM, to check the encrypted cipher text for message integrity. Assuming the authentication tag is valid, the encrypted cipher text can be decrypted.

5. Decrypt the credit card and transaction information using the initialization vector supplied and the created AES encryption key.

Using this system, the Key Escrow beneficiary is not required to install and use any cryptosystem whatsoever when it comes to protecting sensitive card holder data.

Further, as a system itself, this shows particular innovations over current cryptographic systems commercially available. The system that houses the Key Escrow Service Beneficiary Database 210 which stores the encrypted card holder and transaction data does not have the access to the decryption keys or the capability to generate the decryption keys to decrypt the data, and within the Key Escrow Service Beneficiary Database 210 each credit card and transaction data record is encrypted with a unique symmetric encryption key.

Appendix A describes details of an additional embodiment.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A cryptographic method comprising:
at a sender, using a sender private key to produce a secret key;
establishing at least one parameter to populate an initialization vector for symmetric encryption;
encrypting data with the secret key, the encryption using the initialization vector populated with the at least one sender established parameter;
sending the encrypted data with the initialization vector to the recipient;
at the recipient, using a recipient private key to recreate the secret key;
at the recipient, using the secret key and the initialization vector to decrypt the encrypted data and further using the at least one parameter populated in the initialization vector as a control parameter in another process.

2. The method of claim 1, wherein the at least one parameter in the initialization vector includes a timestamp.

3. The method of claim 1, wherein the at least one parameter in the initialization vector includes a source or origin data (location).

4. A server adapted to create a sender private key for a sender and a recipient private key for a recipient, the sender private key along with recipient identification parameter information being sufficient to produce a secret key, the recipient private key along with sender's control parameter information being sufficient to reproduce the secret key; and
wherein when the secret key is used to encrypt data along with an initialization vector encrypted data is produced, the encrypted data and transported control parameters about or of the encrypted information within the initialization vector and when the encrypted data is decrypted using the reproduced secret key at the recipient, the data can be further acted on using parameters in the initialization vector to drive a separate process.

5. The server of claim 4, wherein the initialization vector and parameters are sent along with the encrypted data from the sender to the recipient

6. The server of claim 4, wherein the initialization vector and parameters includes a timestamp.

7. The server of claim 4, wherein the initialization vector includes a source or origin data (location).

8. The server of claim 4, wherein the initialization vector includes control parameters of the digitized data.

9. A machine readable storage medium containing code to cause a machine to:
obtain a sender private key;
use the sender private key to produce a secret key;
encrypt data with the secret key using an initialization vector, the initialization vector including a control parameter for another process; and
send the encrypted data and initialization vector to a recipient so that the receiver is able to decrypt the encrypted data using a reproduced secret key and the initialization vector and use the control parameter in the initialization vector for the another process.

10. The machine readable medium of claim 9, wherein the control parameter in the initialization vector includes a timestamp.

11. The machine readable medium of claim 9, wherein the control parameter in the initialization vector includes a source or origin data (location).

12. A machine readable medium including code to:
receive encrypted data with an initialization vector, the initialization vector including a key escrow beneficiary identifier and a unique/random identification parameter;
obtain a key escrow beneficiary private key using the key escrow beneficiary identifier;
reproduce a decryption key programmatically using the key escrow beneficiary private key and the unique/random identification parameter;
decrypt the encrypted data using the decryption key and the initialization vector.

13. An encryption method comprising:
encrypting data using an initialization vector, the initialization vector including a key escrow beneficiary identifier and a unique/random identification parameter, wherein the initialization vector is sent as part of the encrypted data to a decrypting entity that uses the key escrow beneficiary identifier portion of the initialization vector to obtain a key escrow beneficiary private key, and uses the unique/random identification parameter portion of the initialization vector and the key escrow beneficiary private key to recreate the encryption key.

14. An encryption method comprising:
creating an encryption key using a private key and an at least one identification parameter;
sending the encryption key and the at least one identification parameter to a user;
at the user, encrypting data using the encryption key and the at least one identification parameter;
sending the encrypted data and the at least one identification parameter from the user to a key escrow beneficiary;
sending the encrypted data and the at least one identification parameter from the key escrow beneficiary to a decrypting location;
at the decrypting location, using the at least one identification parameter to identify the beneficiary to obtain a copy of a private key and using the private key and the
at least one identification parameter to recreate the encryption key;
at the decrypting location, decrypting the encrypted data using the encryption key.

15. The encryption method of claim 14 wherein the at least one identification parameter are part of an initialization vector for the data encryption and decryption.

16. The encryption method of claim 14 wherein the at least one identification parameter includes a key escrow beneficiary identifier and another unique or random identification parameter as a control parameter to derive the encryption key.

17. The encryption method of claim 16, wherein the unique identifier is randomly generated.

18. The encryption method of claim 16, wherein the key escrow beneficiary identifier is used to look up the private key.

19. The encryption method of claim 15, wherein the data is a credit card number.
